(19) United States
(12) Patent Application Publication
(10) Pub. No.: US 2012/0092259 A1
(43) Pub. Date: Apr. 19, 2012

(54) TOUCHPAD KEYBOARD WITH ELECTRONIC PAPER DISPLAY

(75) Inventors: YUNG-LUNG LIU, Ta Ya Shiang (TW); Shih-Pin Lin, Ta Ya Shiang (TW); Chun-Jung Liao, Ta Ya Shiang (TW)

(73) Assignee: Sunrex Technology Corp., Ta Ya Shiang (TW)

(21) Appl. No.: 12/906,073

(22) Filed: Oct. 16, 2010

(51) Int. Cl. G06F 3/02; G06F 3/041

(52) U.S. Cl. 345/168; 345/173

(57) ABSTRACT

A touchpad keyboard includes a microprocessor; a touchpad module comprising a flexible, rectangular, optically transmissive touchpad and a touchpad controller electrically interconnecting the touchpad and the microprocessor; and an electronic paper (e-paper) display module comprising a flexible, rectangular e-paper display disposed under the touchpad, and an e-paper display controller electrically interconnecting the e-paper display and the microprocessor. The e-paper display includes a plurality of selection keys, each selection key being adapted to cause the microprocessor to access one of a plurality of keyboard layout pages to display on the e-paper display in response to pressing thereon.

### BACKGROUND OF THE INVENTION

1. Field of Invention

The invention relates to keyboards and more particularly to a touchpad keyboard having an electronic paper (e-paper) display with improved characteristics.

2. Description of Related Art

Touchscreens and touchpads as input devices are becoming increasingly popular in the fields of computers, cellular phones, etc. because of their ease and versatility of operation. For example, touchpad allows a user to make selections and move a cursor on the screen by simply moving one finger thereon. It is similar to computer mouse operation.

Typically, a character printing membrane of a touchpad of a touchpad keyboard is provided with a plurality of virtual keys each printed with a character, number, or function number. In short, the characters printing membrane is fixedly formed on the touchpad. There many different keyboard layouts arise because different people need easy access to different symbols. In one example, this is because they are inputting text in different languages, i.e., so-called national layouts. Following is a description of an example: A business person may travel between Taiwan and Spain. He or she may bring a laptop computer having a touchpad as a personal belonging when travelling. He or she may have the need of inputting text in Chinese when in Taiwan and inputting text in Spanish when in Spain. However, as discussed above the characters printing membrane is fixedly formed on the touchpad of the laptop computer. Hence, the person has to buy two laptop computers of different national layouts (i.e., Spanish keyboard layout and Chinese keyboard layout) in which the laptop computer with Spanish keyboard layout will be carried when traveling to Spain and the laptop computer with Chinese keyboard layout will be used when in Taiwan. Further, in some situations the person may have to carry both laptop computers when traveling to Spain. This is very inconvenient.

Thus, it is desirable of providing a touchpad keyboard with an electronic paper display so that a user may switch between at least two different national layouts by simply pressing a switching device of the touchpad keyboard of, for example, a laptop computer.

### SUMMARY OF THE INVENTION

It is therefore one object of the invention to provide a touchpad keyboard having an e-paper display so that a user may press one of a plurality of selection keys thereon to access a desired national layout to display on the e-paper display.

To achieve the above and other objects, the invention provides a touchpad keyboard comprising a microprocessor; a touchpad module comprising a flexible, rectangular, optically transmissive touchpad and a touchpad controller electrically interconnecting the touchpad and the microprocessor; and an e-paper display module comprising a flexible, rectangular e-paper display disposed under the touchpad, and an e-paper display controller electrically interconnecting the e-paper display and the microprocessor, wherein the e-paper display comprises a plurality of selection keys, each selection key being adapted to cause the microprocessor to access one of a plurality of keyboard layout pages to display on the e-paper display in response to pressing thereon.

The above and other objects, features and advantages of the invention will become apparent from the following detailed description taken with the accompanying drawings.

### BRIEF DESCRIPTION OF THE DRAWINGS

FIG. 1 is an exploded view of a touchpad keyboard according to a first preferred embodiment of the invention;

FIG. 2 is a block diagram of an e-paper display incorporated in the touchpad keyboard;

FIG. 3 is a block diagram of the e-paper display module of FIG. 2;

FIG. 4 is an enlarged view of a portion of the e-paper display of FIG. 1;

FIG. 5 is an exploded view of a touchpad keyboard according to a second preferred embodiment of the invention;

FIG. 6 is a block diagram of an e-paper display incorporated in the touchpad keyboard of FIG. 5; and

FIG. 7 is a longitudinal sectional view of the opaque touchpad of FIG. 5.

### DETAILED DESCRIPTION OF THE INVENTION

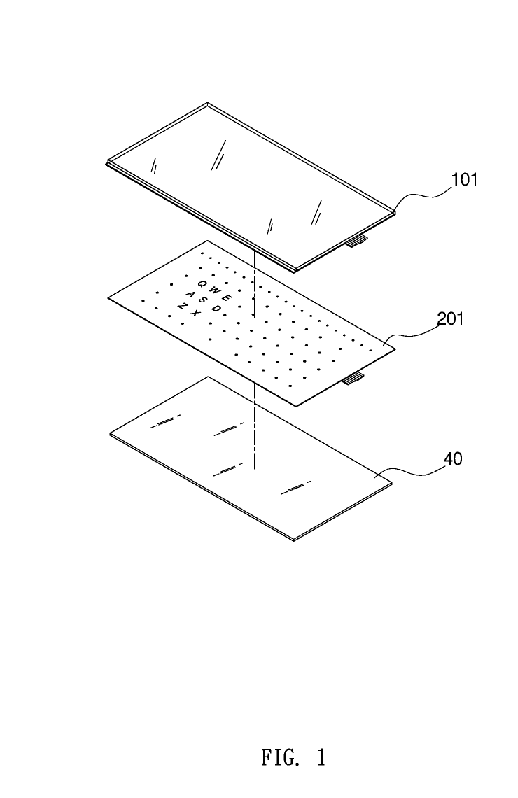

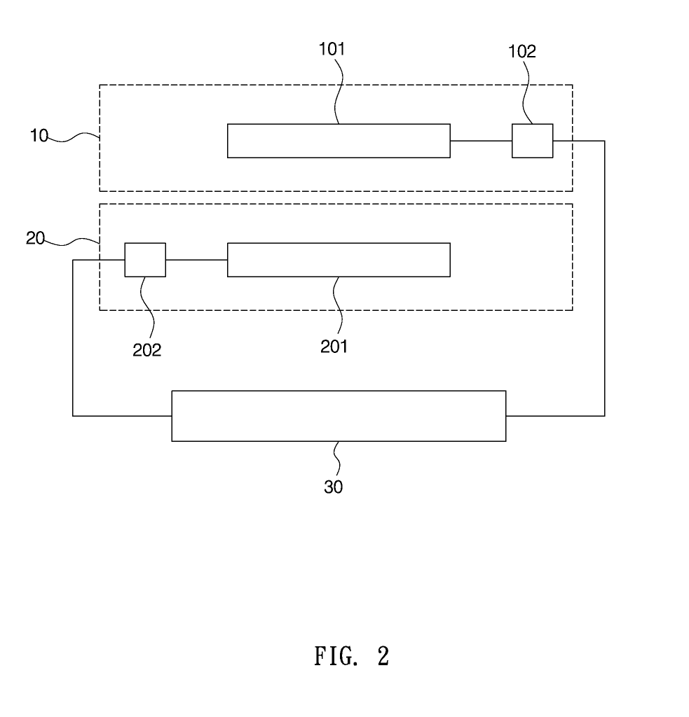

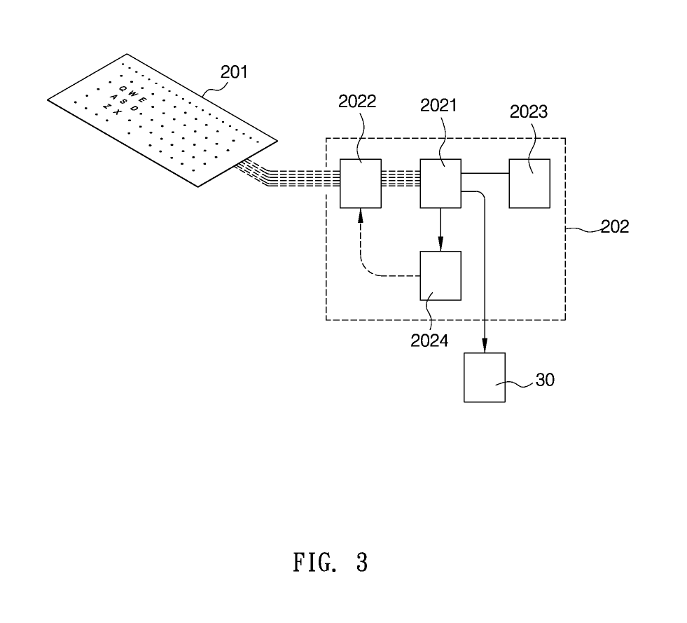

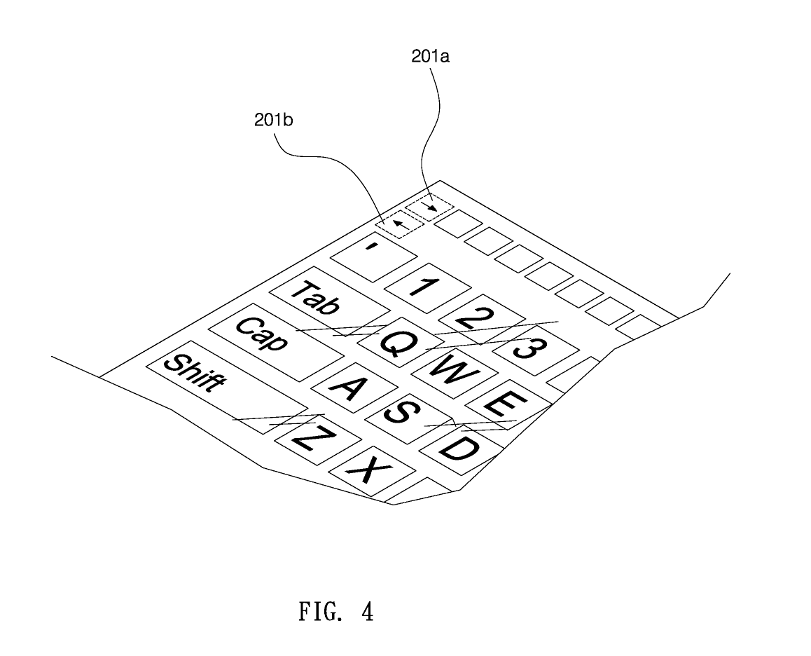

Referring to FIGS. 1 to 4, a touchpad keyboard in accordance with a first preferred embodiment of the invention comprises the following components as discussed in detail below.

A touchpad module 10 comprises a flexible, rectangular, optically transmissive touchpad 101 and a touchpad controller 102. The touchpad 101 comprises a top ITO glass and a bottom ITO film separated by a plurality of spacers therebetween. Touchpad is a well known device so that a detailed description thereof is omitted herein for the sake of brevity. The touchpad controller 102 is electrically interconnected the touchpad 101 and a microprocessor 30 which is in turn electrically connected to a host computer. The touchpad controller 102 is capable of converting an analog signal generated by pressing the touchpad 101 by a user into a digital signal, calculating position of the finger touch in the form of coordinate position, converting the coordinate position into a touch signal, and sending the touch signal containing the coordinate position to the microprocessor 30 via a serial bus, thereby effecting a touchpad input. A loudspeaker or a vibrator (both not shown) can be activated when the touch signal is created so as to either audibly or physically alert the user about the successful touch.

An electronic paper (e-paper) display module 20 comprises a flexible, rectangular e-paper display 201 and an e-paper display controller 202. The e-paper display 201 is provided under the touchpad 101. The e-paper display controller 202 comprises a display micro-controller 2021 electrically connected to the microprocessor 30 for controlling display signals of the e-paper display 201, a driver chip 2022 for sending the display signals from the display micro-controller 2021 to the e-paper display 201, an SRAM (static random access memory) 2023 for storing a plurality of pages of different layouts, and a power supply 2024 controlled by the display micro-controller 2021 for supplying power to the driver chip 2022.

The e-paper display 201 is implemented as an electrophoretic display and can form visible images by rearranging charged pigment particles using an applied electric field. In a simplest implementation of an electrophoretic display, titanium dioxide particles approximately one micrometer in diameter are dispersed in hydrocarbon oil. A dark-colored dye is also added to the oil, along with surfactants and charging agents that cause the particles to take on an electric charge. This mixture is placed between two parallel, conductive plates separated by a gap of 10 to 100 micrometres. When a voltage is applied across the two plates, the particles will migrate electrophoretically to the plate bearing the opposite charge from that on the particles. When the particles are located at the front viewing side of the display, it appears white, because light is scattered back to the viewer by the high-index titanium particles. When the particles are located at the rear side of the display, it appears dark, because the incident light is absorbed by the colored dye. If the rear electrode is divided into a number of pixels, then an image can be formed by applying the appropriate voltage to each region of the display to create a pattern of reflecting and absorbing regions. E-paper displays have the potential to be more comfortable to read than conventional displays. This is due to the stable image, which does not need to be refreshed constantly, the wider viewing angle, and the fact that it reflects ambient light rather than emitting its own light. An e-paper display can be read in direct sunlight without the image appearing to fade.

On the left top corner of the e-paper display 201, there are provided two selection keys 201a, 201b. A user may press one of the selection keys 201a, 201b to activate the microprocessor 30 to access a desired layout (i.e., national layout) from the SRAM 2023 to display on the e-paper display 201.

The microprocessor 30 is electrically connected the touchpad controller 102 and the e-paper display controller 202. Further, the microprocessor 30 is electrically connected to a host computer.

The flexible touchpad 101 is provided on the flexible e-paper display 201 which is in turn provided on a flexible, insulative bottom base 40. The bottom base 40 thus serves to support the touchpad keyboard.

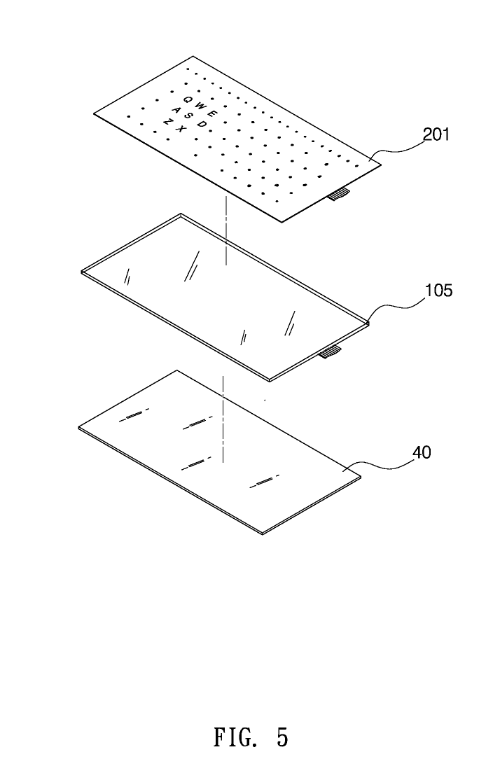

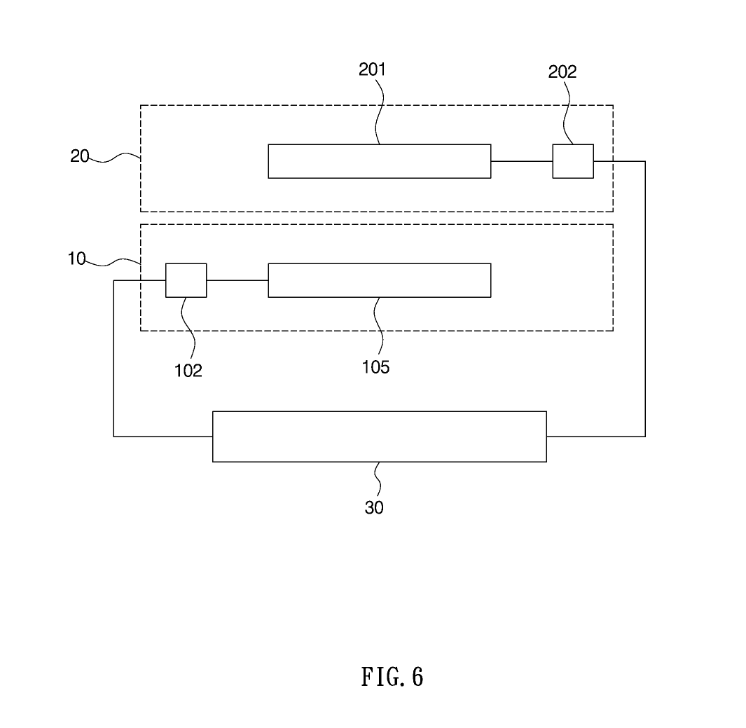

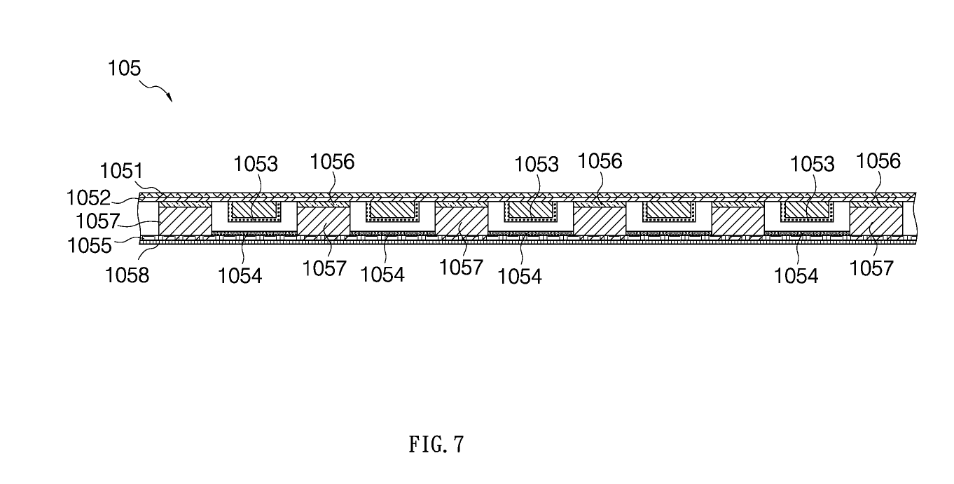

Referring to FIGS. 5 to 7, a touchpad keyboard in accordance with a second preferred embodiment of the invention is shown. The characteristics of the second preferred embodiment (i.e., the differences between the first and second preferred embodiments) are detailed below.

The optically transmissive touchpad is replaced by an opaque touchpad 105 which is disposed between the e-paper display 201 and the bottom base 40. In addition to the flexible, rectangular, opaque touchpad 105, the touchpad module 10 further comprises a touchpad controller 102. A user may press one of a plurality of keys on the e-paper display 201 for keying and inputting computer commands. The portion of the opaque touchpad 105 corresponding to the pressing is thus depressed and activated. The opaque touchpad 105 is a resistive touchpad and comprises, from top to bottom, a top substrate 1051 formed of PET (polyethylene terephthalate), a first conduction layer 1052 adhered to the top substrate 1051, a first sensing layer 1053 formed of sensing material and adhered to the first conduction layer 1052, the first sensing layer 1053 projecting downward, a second sensing layer 1054 formed of sensing materials and spaced apart from the first sensing layer 1053 by a distance, a second conduction layer 1055 adhered to the second sensing layer 1054, and a bottom substrate 1058 formed of PET.

Between the first conduction layer 1052 and the second conduction layer 1055, there are provided a plurality of posts 1057 as spacers. The post 1057 has a bottom end adhered to the second conduction layer 1055 and a top end secured to the first conduction layer 1052 by means of an adhesive layer 1056. The posts 1057 and the first sensing layers 1053 are arranged transversely in alternating fashion.

The touchpad controller 102 is capable of converting an analog signal generated by pressing the opaque touchpad 105 by a user into a digital signal, calculating position of the finger touch in the form of coordinate position, converting the coordinate position into a touch signal, and sending the touch signal containing the coordinate position to the microprocessor 30 via a serial bus, thereby effecting a touchpad input.

Preferably, the touchpad keyboard is either rigid as a typical keyboard or flexible for ease of transport.

Preferably, the touchpad keyboard can be connected to a desktop computer, a laptop computer, or any of other electronic appliances as character and command input device.

Advantages and characteristics of the invention are described below. The touchpad keyboard comprises a touchpad module 10, an electronic paper (e-paper) display module 20, and a microprocessor 30. The touchpad module 10 comprises a flexible, rectangular, optically transmissive touchpad 101 and a touchpad controller 102. The e-paper display module 20 comprises a flexible, rectangular e-paper display 201 and an e-paper display controller 202. The e-paper display 201 is provided under the touchpad 101. On the e-paper display 201, there are provided two selection keys 201a, 201b. A user may press one of the selection keys 201a, 201b to access a desired layout (i.e., national layout) from the memory to display on the e-paper display 201. Images shown on the e-paper display 201 are not required to be refreshed constantly, i.e., energy saving. The e-paper display 201 can be read clearly without the image appearing to fade.

While the invention has been described in terms of preferred embodiments, those skilled in the art will recognize that the invention can be practiced with modifications within the spirit and scope of the appended claims.

What is claimed is:

1. A touchpad keyboard comprising:
a microprocessor;
a touchpad module comprising a flexible, rectangular, optically transmissive touchpad and a touchpad controller electrically interconnecting the touchpad and the microprocessor; and
an electronic paper display module comprising a flexible, rectangular electronic paper display disposed under the touchpad, and an electronic paper display controller electrically interconnecting the e-paper display and the microprocessor,
wherein the electronic paper display comprises a plurality of selection keys, each selection key being adapted to cause the microprocessor to access one of a plurality of keyboard layout pages to display on the electronic paper display in response to pressing thereon.

2. The touchpad keyboard of claim 1, wherein the touchpad comprises a top ITO glass, a bottom ITO film, and a plurality of spacers for separating the ITO glass from the ITO film.

3. The touchpad keyboard of claim 1, wherein the microprocessor is electrically connected to a host computer, and wherein the touchpad controller is adapted to convert an analog signal generated by pressing the touchpad into a digital signal, calculate position of the pressing in a form of coordinate position, convert the coordinate position into a touch signal, and send the touch signal containing the coordinate position to the microprocessor via a serial bus.

4. The touchpad keyboard of claim 1, wherein the electronic paper display controller comprises a display micro-controller electrically connected to the microprocessor for controlling display signals of the electronic paper display, a driver chip for sending the display signals from the display micro-controller to the electronic paper display, an SRAM (static random access memory) for storing a plurality of pages of different layouts, and a power supply controlled by the display micro-controller for supplying power to the driver chip.

5. The touchpad keyboard of claim 1, further comprises a flexible, insulative bottom base disposed under the electronic paper display.

6. A touchpad keyboard comprising:
a microprocessor;
an electronic paper display module comprising a flexible, rectangular electronic paper display and an electronic paper display controller electrically interconnecting the electronic paper display and the microprocessor wherein the electronic paper display comprises a plurality of selection keys, each selection key being adapted to cause the microprocessor to access one of a plurality of keyboard layout pages to display on the electronic paper display in response to pressing thereon, and
a touchpad module comprising a flexible, rectangular, opaque touchpad disposed under the electronic paper display, and a touchpad controller electrically interconnecting the touchpad and the microprocessor.

7. The touchpad keyboard of claim 6, wherein the touchpad is resistive and comprises a top substrate formed of PET (polyethylene terephthalate), a first conduction layer adhered to the top substrate, a first sensing layer formed of sensing material and adhered to the first conduction layer, the first sensing layer projecting downwardly, a second sensing layer formed of sensing material and spaced from the first sensing layer by a predetermined distance, a second conduction layer adhered to the second sensing layer, a bottom substrate formed of PET, and a plurality of posts disposed between the first conduction layer and the second conduction layer, each of the posts having a bottom end adhered to the second conduction layer and a top end secured to the first conduction layer by means of an adhesive layer, and wherein the posts and the first sensing layers are arranged transversely in alternating fashion.

8. The touchpad keyboard of claim 6, wherein the microprocessor is electrically connected to a host computer.

9. The touchpad keyboard of claim 6, wherein the touchpad controller is adapted to convert an analog signal generated by pressing the touchpad into a digital signal, calculate position of the pressing in a form of coordinate position, convert the coordinate position into a touch signal, and send the touch signal containing the coordinate position to the microprocessor via a serial bus.
